(19) United States
(12) Patent Application Publication
(10) Pub. No.: US 2007/0193934 A1
(43) Pub. Date: Aug. 23, 2007

(54) Perforated surface for sample preparation

(76) Inventors: Ashok Kumar Shukla, Ellicott City, MD (US); Mukta Misra Shukla, Ellicott City, MD (US)

Correspondence Address: ASHOK K. SHUKLA, 10316 KINGSWAY COURT, ELLICOTT CITY, MD, 21042, US

(21) Appl. No.: 11/699,090

(22) Filed: Jan. 29, 2007

Related U.S. Application Data
(60) Provisional application No. 60/763,466, filed on Jan. 28, 2006.

(51) Int. Cl. B01D 15/08

(52) U.S. Cl. 210/198.2; 436/161; 422/70; 210/502.1

(57) ABSTRACT

In the present invention, we describe a device and a method that shows the use of a perforated surface (e.g. net, grid, mesh etc.) for the preparation of small biological and chemical samples. In this present invention, the sample is concentrated on the edges of the perforation. If a solution of chemical or biological sample is applied on the perforated area; upon drying the solvent, the solute will concentrate on the edges of the perforation. This offers a novel method for the sample concentration. The perforated surface can be directly placed in the MALDI instrument for sample analysis. Furthermore, the edges of the perforation of the perforated surface can be modified, treated or coated with different chromatographic materials and thus have the retention property for analyzing the molecules. The woven net may contain not just single but double or more threads that creates a capillary effect, which further enhances the sample purification and concentration.

### FIELD OF THE INVENTION

In the present invention, we describe a device and a method that shows the use of a perforated surface (e.g. net, grid, mesh etc.) for the preparation of small biological and chemical samples. In this present invention, the sample is concentrated on the edges of the perforation. If a solution of chemical or biological sample is applied on the perforated area; upon drying the solvent, the solute will concentrate on the edges of the perforation. This offers a novel method for the sample concentration. The perforated surface can be directly placed in the MALDI instrument for sample analysis.

Furthermore, the edges of the perforation of the perforated surface can be modified, treated or coated with different chromatographic materials and thus have the retention property for analyzing the molecules.

The woven net may contain not just single but double or more threads that creates a capillary effect, which further enhances the sample purification and concentration.

### BACKGROUND OF THE INVENTION

Definitions:

Mesh, Net (woven-net or non-woven net), perforated surface, flat perforated surface, perforated area (round, rectangular, of regular geometry, irregular geometry), solid (of any shape) surface with holes—are the similar products. The surface can be made of synthetic, natural, plastic, polymer, wood, fabric, metallic, non-metallic, magnetic, non-magnetic, glass, paper or a combination of any of these materials. The surface can also be made of thread, woven, molded (non woven) or a combination of both. The material of these threads or net can be natural polymer, synthetic polymer, polymer, glass, plastic, metallic, non-metallic, magnetic, non-magnetic or a combination thereof.

Perforation: means a through hole (open at both ends) on a surface.

Hole: on the surface means an opening or through hole (open at both ends) or a well type hole (open at one end).

Perforated Surface or Area: means a surface or area perforated with a number of holes, for example: a filter, a net, a 3-dimensional wire- or thread-mesh, woven or non woven mesh or net.

Sample (analytes): means any sample from a chemical or biological source and the sample may contain several molecules. Sample preparation means the purification and separation of different molecules in the sample.

Solvent: means organic and inorganic solvents including water, buffers, solutions.

Solute: means a solid or semi solid, high boiling liquids dissolved in the solvent and left as a residue after the evaporation of the solvent.

Chromatographic Media: means beads, porous or non-porous beads, spherical or non spherical particles or broken fragments of silica, metal, polymer, titanium, zirconium, metal and non metal oxides, affinity, gels, bacteria, living cells and their compounds and derivatives for the purpose of chromatography or retention of the analytes. The size of chromatographic media can be in a range of 0.0001-1 mm.

Background:

Small sample preparation is typically performed to concentrate and/or clean up samples by removing impurities such as detergent, salt or other molecules, prior to performing sample analysis by different analytical tools such as HPLC, Mass spectrometry, electrophoresis. The present invention describes a system and a unique method for small sample preparation, concentration, as well as, separation of different components comprising a sample.

Currently, different methods are used for sample preparation including spin columns, pipette tip columns and other solid phase extraction columns that are filled with desired chromatographic materials. One of the main limitations of the currently available methods is that they are typically used for larger samples and are not well suited for miniaturization as required for high-throughput screening and other methods that use micro volumes of many different samples for analysis. Yet, many new technologies and sample analysis methods such as MALDI and mass-spectrometry require very small volumes (nano liters) of a sample for analysis.

Furthermore, separation columns such as the ones listed above, can prepare only one sample at a time per column and each use is usually limited to the use of one type of chromatographic material. This limits the separation of different types of components of a sample and limits the level of sophistication obtained in subsequent sample analysis.

### SUMMARY OF THE INVENTION

The present invention overcomes many limitations of existing methods by providing a system for preparing many different samples, using many different separation and chromatographic materials simultaneously.

In present invention a perforated surface is used for the sample preparation and concentration.

The edges of perforation on a surface can contain chromatographic or separation material. The separation media or chromatographic particles are coated onto the surface of the edge of the perforation, surface between two perforations and at the inner wall of the hole. The chromatographic particles or separation media can be attached to the said surface, through the use of a polymer matrix using pressure, temperature, physical or chemical means, laser, ultrasonic, during the molding or any other means.

In the present invention a net, (grid or mesh) is comprised of polymer, synthetic, natural polypropylene, polystyrene, glass, polyethylene, PTFE (polytetrafluoroethylene), metal (magnetic or non-magnetic, alloys, metal compounds, carbon, or other plastics or materials (which is capable of forming the net or perforated surface), and combinations thereof. Furthermore, the net material can be modified chemically, physically, or biologically.

Furthermore, the net surface can be coated with a coating which can possess a retention property of analytes or biomolecules. The coating can be achieved by spray, screen printing, dipping, brushing, powder coating, wet coating or any other means that can coat a molecule or compound on the surface. The coating may contain more than one compound or molecules.

Furthermore, the net itself is made of a certain material (molecule retention properties) that can take part in the purification of the sample. For example if net is made of silver, it will remove the chloride ions, thus net itself is taking part in the chemical reaction.

Furthermore, the net can be attached to thin layer chromatography plate or film.

The said chromatographic media or separation particles, which have the properties to retain certain molecules, based on their chemical or physical properties, can be selected from the group consisting of, but not limited to, porous, nonporous, silica, non-silica, polymer-based, active charcoal, graphite, carbon, metal, metal oxides, metal compounds, zirconium, titanium, affinity chromatography, dye affinity molecules, synthetic dyes, solid powder, or other materials and combination thereof. Said chromatographic particles (9) spot can also contain gels, bacteria, biomolecules, living cells, radioactive molecules, solid or metal powders and any other materials. Also, the chromatographic (9) particles (9)can be chemically or physically modified and may be porous or non-porous. The size of said chromatographic material (9) particles can be from 100 nanometers to 100 micrometers.

The chromatographic particles can be attached to the perforated surface by entrapping the particles in a polymer net coating in such a way that the particles retain their properties to bind the analytes. The entrapment can be achieved by using inert polymers such as Teflon, polypropylene, polystyrene or any other polymer, which is inert to the solvents and can entrap the particles physically.

Furthermore, the mesh or net can be attached to a surface so that the open area of net can behave like wells. The attachment to the surface can be achieved by glue, thermal, ultrasonic, laser, pressure, or by any other physical or chemical method The surface can have also retention properties of the molecules; this can be achieved by the using chromatographic media (as described above) at the surface to which the net is attached. This combination of net and surface can be used for a thin layer chromatographic application for the purification of a sample mixture. Furthermore, threads made of different materials can be used to attain different retention properties so as to get different effects or results and to get an array of sample prep.

A biological sample can be applied to the said area containing the separation media. Based on the properties of said chromatographic or separation material, said sample will be purified. The properties of the purified sample can be analyzed using HPLC (high pressure liquid chromatography), HPCE (high pressure capillary electrophoresis), mass spectrometry, MALDI, electrophoresis or any other relevant analytical methods.

Furthermore, the perforated area can be used to concentrate the sample itself. When a solution containing the sample, is placed on the perforated area, due to surface tension the droplet will be hanging between the perforation edges. Once the solution has evaporated, the solid will be deposited on the edges of the perforation or hole; as compared to the normal surface without the perforation where the sample will spread over the entire area of the droplet of the solution. Furthermore, the sample on the net can be dried or concentrated by using vacuum, blowing air, pressure or by use of heat, laser and a combination thereof.

Furthermore, a gel piece containing analytes such as proteins after the gel electrophoresis, can be placed on the net to concentrate the analytes.

Furthermore, the net can also be made in such a way that an electric current can be passed between the two edges of the perforation or the entire net to take advantage of the electric-charge and electrical current in the purification of molecules.

A further embodiment is that the perforated surface can be in the form of woven or non-woven net. The woven net may contain not just single but double or more threads to form the net which gives a capillary effect. This capillary effect is very useful in sample preparation. For example, once the solution is placed in the net with double or more thread combinations, the solution will flow only in one direction (the direction of multiple threads) due to the capillary effect. This capillary effect is used to purify the sample as the solute dissolved in the solution may interact with the material that the net (or thread) is made of or the chromatographic material coated on it. Different types of threads (made of different materials) can be used in this capillary effect. Furthermore, the surface can be coated with a material in such a way that it can give surface tension properties to get different effects on analyzing molecules. The woven net may contain different types of threads (the threads can be made of different materials, such as polymers, synthetic, natural fibers, metal, glass, viscose, or a combination thereof. Furthermore, this thread can be coated with the chromatographic materials. The thread itself can be modified in such a way that it retains the analytes.

A further embodiment is that the net or perforated surface has affinity to certain molecules under certain physical or chemical conditions; that means that under one set of conditions the analytes of interest can bind to the surface and under another set of conditions the molecules can be eluted.

The affinity effect can be achieved by attaching the chromatographic particles or media to the thread of the net or perforated surface. This can be achieved by chemical or physical modifications of net or chromatographic particles. The fibers can be made of porous or non-porous materials.

Furthermore, this sample preparation method can be used in combination with automatic sample prep., Robotics or auto samplers, fraction collector. The samples can be collected on the net (described here) after purification from column chromatography.

Furthermore, the device and methods described in this invention can also be used for the clinical diagnosis of biomolecules.

The net can be folded or molded in any shape for example cylindrical, spherical, cubical.

The present invention has the following advantages:

Easy to use

Suited for small sample volumes (micro/nano liters)

Simultaneous preparation and analysis of a large number of samples

Inert materials such as Teflon can be used.

Simultaneous use of many different types of separation/chromatographic materials

Versatile

Economical

Fast

Minimal sample loss

The various features of novelty, which characterize the present invention, are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, alongwith various advantages and features of novelty residing in the present embodiments, from study of the following drawing, in which:

FIG. 1 is an expanded view of one embodiment of an area on a surface where said area is perforated.

FIG. 2 is an expanded view of one embodiment of a net.

FIGS. 3a, 3b is an expanded view of one embodiment of a net, where two threads are used to get capillary effect.

FIG. 4, is an expanded view of one embodiment of surface, where non-perforated area contains chromatographic particles.

FIGS. 5 and 6, is expended view of one embodiment of surface, where non-perforated area contain different retention properties in array.

FIG. 7 shows different shape of perforation may present on the surface.

FIG. 8 shows arrays on the perforated area.

FIG. 9 shows the upper and lower side of the perforated surface.

FIG. 10. The polymer which block the capillary effect.

### DESCRIPTION OF THE PREFERRED EMBODIMENTS

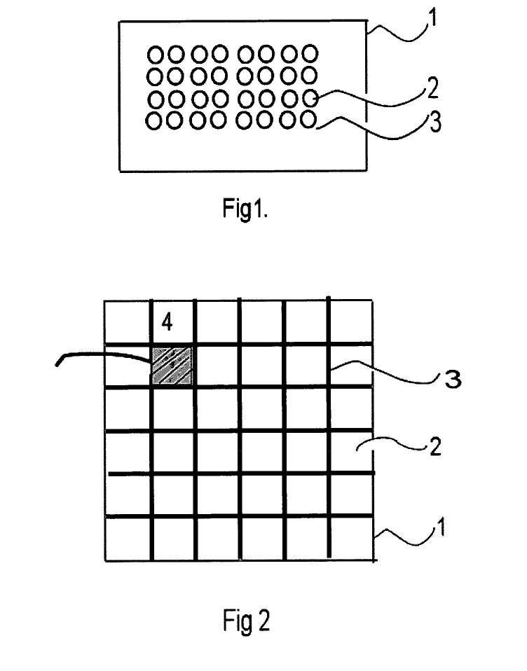

Referring to the drawings, FIGS. 1 and 2 show a surface (1) that contains perforations (hole)(2. The non-perforated area (3) contains a sample solution (4). The surface (1) can be of any shape or size and may consist of any shape or volume from the group consisting of but not limited to a flat surface, an irregular surface or shape, a cube, cylinder, pyramid, sphere or any other type of configuration suited to the applications of the present invention. Said surface (1) may be made of any materials, porous or non-porous, synthetic or natural, from the group consisting of synthetic, natural, plastics, polymers, wood, metal, non-metal, glass, fabric and paper. The surface (1) can also be magnetic or possess magnetic properties so that it can be attached to another magnetic surface with magnetic properties (for example, the magnetic properties can be used to attach the surface (1) to a MALDI plate). The hole or perforation (2) can be of any shape, such as round, cube, rectangular, triangular, circular, conical, tapered, regular, irregular or a combination thereof (FIG. 7). The depth of the perforation can be as low as 1 micro meter and as large as 10 mm. The surface (1) can have holes of different shapes on the same surface (FIG. 7). The diameter or size of the hole can also be different on the same surface (1). The ratio of the surface area between open (perforated) area (2) and the solid area (3) should be such that at least 10% of total surface area is open area.

In FIGS. 1. and 2. the thickness of the said perforated surface (depth of holes) can be in between 0.0001-10 mm and the distance between two said holes on said surface can be between 0.0001-10 mm. The different size and shape of holes may be present at the said surface.

FIG. 2. shows the surface (1) in a net shape. The net can be woven or non-woven. Can be made of polymer, natural, synthetic, metal, non-metal and combination of any different thread or surface (if non-woven).

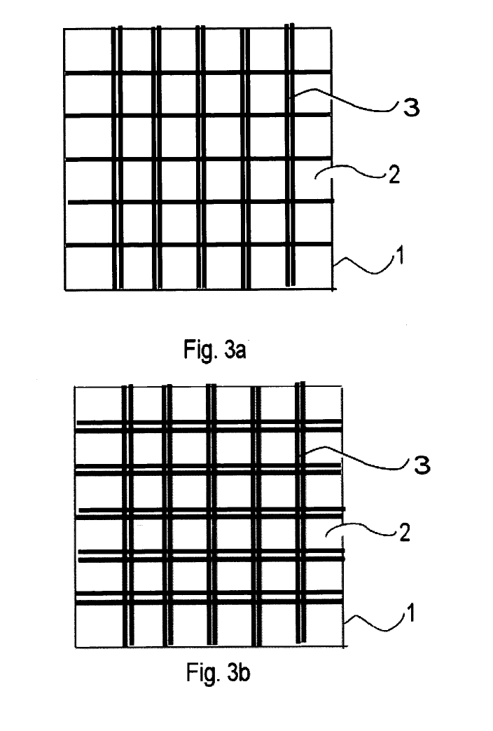

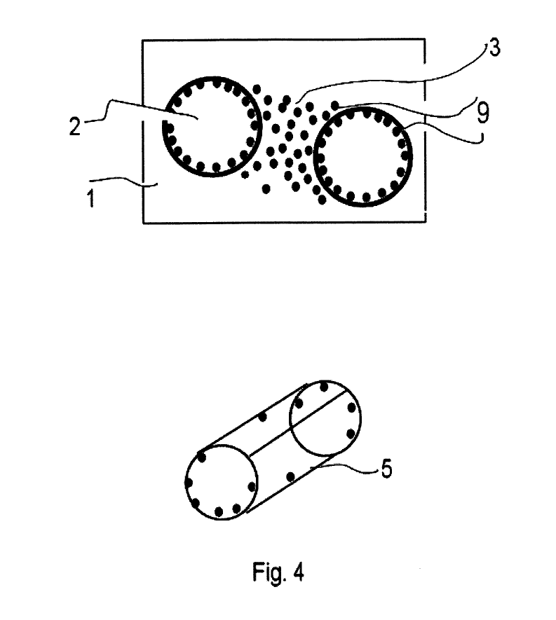

FIG. 3a shows that the net is woven in one direction with two or more threads to create the surface tension property between the threads so that sample can be cleaned up by using the surface tension (capillary-effect) properties of the solvent. The thread can be straight or in a twisted form.

FIG. 3b shows that the threads can be single or multiple in both directions (X- as well as Y-axis).

FIG. 4 shows chromatographic particles (9) attached to the edge or internal wall (5) of the hole and/or on the non-perforated area of the surface.

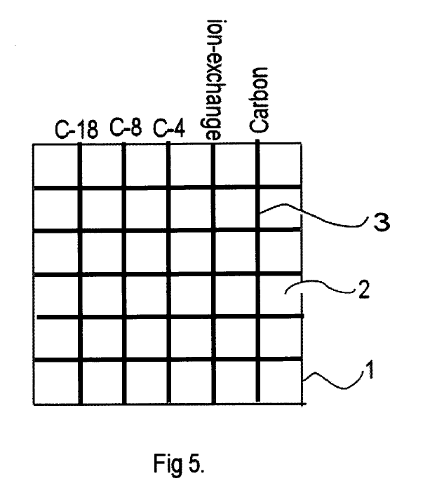

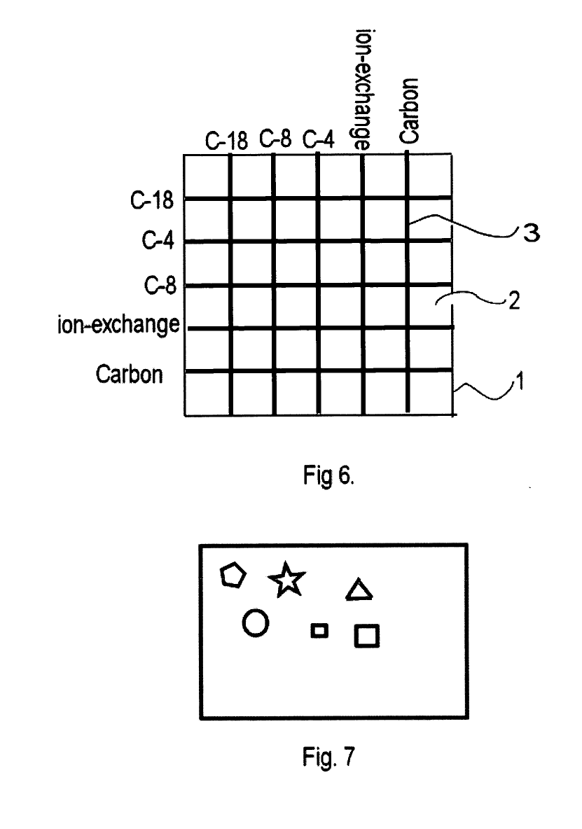

FIG. 5 shows that threads of different properties can be used to get the array of different properties to get the sample separation as well as cleanup by using the affinity to the different thread properties. Different threads can be used in one direction or both directions (FIGS. 5 and 6)

FIGS. 5 & 6 show that the same surface (1) can have different types as well as size of holes.

The size of hole on surface (1) can be larger than one micron and the hole may be of any shape, thickness, diameter or size. The distance between any two holes (2) in an array, as shown in FIGS. 1 and 2, may be larger than 2 microns. Said holes can be placed on said surface in any arrangement. Samples prepared using the present invention can be analyzed using HPLC, mass spectrometry, MALDI or using any other qualitative or quantitative analytical methods.

The chromatographic material (9) can consist of one or more materials from the group comprised of, but not limited to porous, nonporous, silica, non-silica, polymer-based, active charcoal, graphite, carbon, zirconium, titanium, affinity chromatography, magnetic particles A device as in claim 1 or 9, wherein the thickness of the said perforated surface can be in between 0.0001-10 mm and the distance between two said holes can be between 0.0001-10 mm.

Sample preparation process can consist of any method used to separate, concentrate or purify molecules, through centrifugation, gravitation, vacuum suction, pressure application, syringe-based sample delivery through the container, or any other applicable methods.

Said spot (9) can also contain gels, bacteria, biomolecules, living cells, bacteria, radioactive molecules, solid or metal powders and any other materials. Also, the chromatographic material (9) particles can be chemically or physically modified and may be porous or non-porous. The size of said chromatographic material (9) particles can be from nanometers to micrometers.

The chromatographic material (9) can also be present in the form of gradient, such that two or more different types of chromatographic materials are placed on an area such that, for example, one side of the hole (2) is composed of hydrophobic material and the other half of the hole is composed of hydrophilic material, with a gradient between the two materials. The same hole can have different type of materials either in horizontal or vertical direction.

The chromatographic material particles can be placed on the solid surface (3) (hole edge) (FIG. 3) reversibly or irreversibly. The particles can be attached to the perforated surface (3) by using any means such as physical, chemical, ultrasonic, laser, heat, pressure, vacuum, glue, by melting, adding the chromatographic material during the molding or preparation of net, and combination of thereof.

The embedding of chromatographic particles can be done directly on the said surface (1) by a means selected from the group comprised of but not limited to, embedding by heat application, embedding by heat based extrusion, embedding by pressure application, embedding by physical force application, embedding by chemical means, embedding by application of electrical current, embedding buy ultrasonication, laser based embedding, microwave based embedding, embedding by welding, embedding by blowing, embedding during the manufacture of said surface. The surface may contain chromatographic material fully or partially at the surface. Different or similar chromatographic particles can be attached to both sides of the net (upper and lower) (FIG. 9). Furthermore, one end may contain one material and the other end may contain the same or different material.

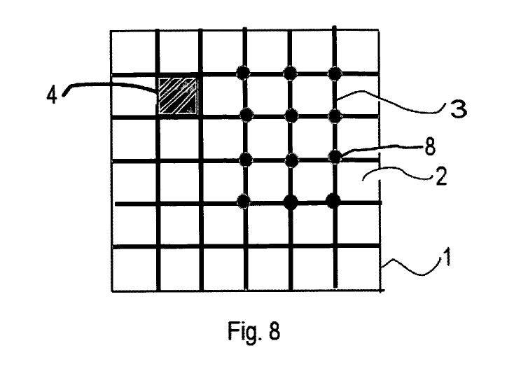

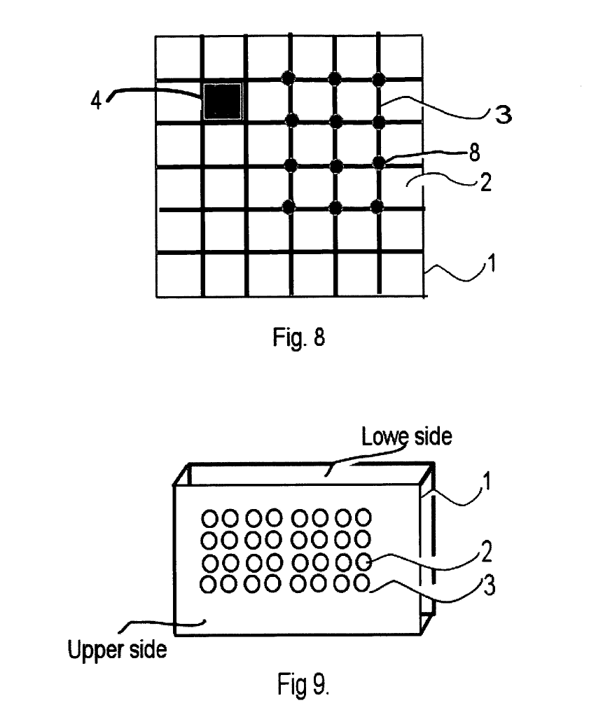

The particles can be entrapped in a polymer as a spot (8) (FIG. 8), when placed on the surface (1). for the preparation and analysis of sample volumes at said spot (8), wherein said spot is formed by evaporation of a solution containing said polymer matrix and said chromatographic material, and wherein said spot size is 0.00005 to 5 mm. Wherein said polymer matrix is selected from the group consisting of polytetrafluoroethylene, polysulfone, polyethersulfone, cellulose acetate, polystyrene, polystyrene/acrylonitrile copolymer, PVDF. wherein said spot contains two or more different types of chromatographic materials in a form such that a gradient forms from one chromatographic material to the other.

The surface (1) and hole (2) can be coated with one or more chromatographic material (9) and may be created in standard 8-, 12-, 96-, 384-, 1536- or larger number of spot formats or in any other formats. Said surface (1) can also be part of a plate that can be used in combination with auto samplers or other sample preparation machines.

The perforation edges can be coated with the MALDI-matrix for the analysis. MALDI- matrix is a chemical that helps in ionization of the molecules in the sample to be analyzed, in the presence of laser. Furthermore, Perforation edges can also be coated with other chemicals that can take part in the reaction during the analysis (for example enzyme reactions, ionization, chemical reaction, affinity binding or any other type of chemical or physical reaction.

The MALDI matrix may be present in the form of a film in the open area of the net which will dissolve upon contact with sample solution and is re-crystallized upon drying on the edges of the open area (perforation) of the net.

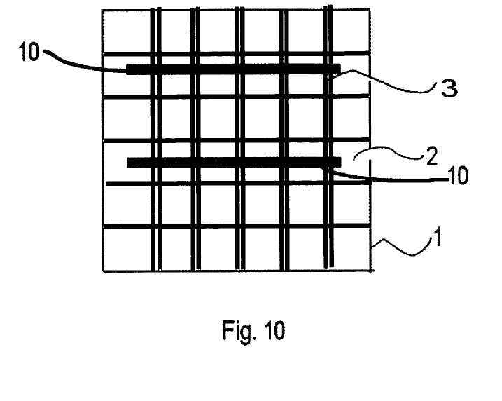

FIG. 10 shows that the flow of the solution due to capillary effect can be stopped by closing the capillary by any means such as glue or polymer layer (10). This will help to concentrate the analytes in the solution on the polymer (10) edge. This polymer can be placed at one end or both ends or at all the four ends of double or multiple threaded net in both the directions as in FIG. 3b.

The device, according to the present invention, can be present in any multi-format form such that said device exists as part of a multi-tube or multi-column format selected from the group comprised of 8-, 12-, 24-, 48-, 96-, 384-, 1536- or higher tube or column formats. Furthermore, the present invention can be used for any sample preparation methods wherein said sample preparation methods are selected from the group comprised of chromatography; high pressure liquid chromatography (HPLC); electrophoresis; gel filtration; sample centrifugation; on-line sample preparation; diagnostic-testing kits; transport of chemicals; transport of biomolecules; high throughput screening; affinity binding assays; purification of said sample; size-based separation of the components of said sample; physical properties based separation of the components of said sample; chemical properties based separation of the components of said sample; biological properties based separation of the components of said sample; electrostatic properties based separation of the components of said sample; and, combinations thereof. Also, the device of the present invention can be part of a larger device or can have a unique function such as being a reaction chamber or spin column.

FIG. 1. wherein said perforated surface contains molecules for further reactions selected from the group consisting of MALDI-matrix, enzymes; reactive metals; catalyst; affinity molecules; receptors; oxidizing and reducing molecules; and, combination thereof. The coating of molecules can be achieved by spray, screen printing, dipping, brushing, powder coating, wet coating or any other means that can coat a molecule or compound on the surface. The coating may contain more than one compound or molecule.

Furthermore, the present invention can be used for the preparation of any types of sample where said samples are selected from the group comprised of biological samples; protein containing samples; nucleic acid containing samples; lipid containing samples; carbohydrates containing samples; cell containing samples; blood containing samples; tissue containing samples; living matter containing samples; mucus containing samples; serum containing samples; chemical samples; biochemical samples; radioactive samples; and, combinations thereof.

The broader usefulness of the present invention may be illustrated by the following examples.

### EXAMPLE 1

### Sample Preparation Using the Mesh

A Polypropylene mesh having the hole size of 2 mm diameter. A 20 ul sample of protein (cytochrom-C) is added to the open surface and let to dry. The solid protein molecules are concentrated on the threads of the mesh. The protein from the mesh is eluted in 5 ul water and analyzed by HPLC. This showed about 4 fold concentration of the protein sample.

### EXAMPLE 2

### Desalting the Sample Using the Mesh Coated with a Chromatographic Material

A Polypropylene mesh having the hole size of 2 mm containing the C18 chromatographic material at its solid surface. The chromatographic material is attached to the surface by heat and pressure. Then, 20 ul of a sample containing Cytochrom C in PBS buffer is applied to the hole and pipetted back and forth 5-10 times. Cytochrom C will bind to the surface containing C-18 while PBS will not. The hole was washed with water 3-4 times and eluted with 50% isopropanol and water solution. The eluted sample was analyzed by HPLC for presence of Cytochrom C in the sample.

While a specific embodiment of the invention has been shown and described in detail to illustrate the application of the principles of the invention, it is understood that the invention may be embodied otherwise without departing from such principles and that various modifications, alternate constructions, and equivalents will occur to those skilled in the area given the benefit of this disclosure and the embodiment described herein, as defined by the appended claims.

What is claimed is:

1. A device comprising a solid surface with perforations (holes) for the sample preparation and concentration of chemical and biological samples, said samples are dissolved in a solution and upon placing the said solution on the said perforated surface the sample will concentrate on the said solid surface.

2. A device as in claim 1, wherein said perforated surface is selected from the group consisting of a sheet; net; woven net; non-woven net; regular surface, irregular surface; flat surface, a cube; cylinder; round or rectangular; and, combinations thereof.

3. A device as in claim 1, wherein the said perforated area is modified chemically, physically or biologically.

4. A device as in claim 1, wherein said solid surface contains chromatographic particles, and said particles can be attached to the said solid surface by a method selected from the group consisting of chemical, physical (including magnetic properties); heat, glue, pressure; laser; coating; and, combinations thereof.

5. Chromatographic particles as in claim 1 or 4, wherein said chromatographic particle are attached to the entire or partial said solid surface.

6. Chromatographic particles as in claim 4, wherein said chromatographic particles are selected from the group consisting of porous or non-porous bead; spherical or non spherical particles or broken fragments of silica; metal; affinity; polymer; titanium; gels; bacteria; living cells; zirconium; metal and non metal oxides; and their compounds and derivatives for the purpose of chromatography; and, combinations thereof.

7. A device as in claim 1, wherein material of said solid surface is selected from the group consisting of polytetrafluoroethylene; polysulfone; polyethersulfone; cellulose acetate; polystyrene; polystyrene/acrylonitrile copolymer; PVDF; natural polymer; synthetic polymer; polymer; glass; plastic; fabric; paper; metallic; non-metallic; magnetic non-magnetic; and, combinations thereof.

8. A device as in claim 1, wherein said sample preparation applications are selected from the group consisting of HPLC; mass spectrometry; MALDI; electrophoresis; qualitative and quantitative analytical methods; and, combination thereof.

9. A device as in claim 1 wherein said perforated surface is a woven net and said net is woven with double or more threads in such a way that a capillary effect can be created for the flow of the fluid during the sample preparation.

10. A device as in claim 9 wherein said device can be placed between two electrodes for the movement of charged molecules in the said sample.

11. A device as in claim 4, wherein the sizes of the said chromatographic material particles are from nanometers to micrometers.

12. A device as in claim 4, wherein said perforated surface contains two or more different types of chromatographic materials in a form such that a gradient forms from one chromatographic material to the other.

13. A device as in claim 4, wherein said perforated surface contains areas of chromatographic particles in multiple spots configuration including but not limited to 2-unit, 8-unit, 48-unit, 96-unit, 384-unit or 1536-unit formats.

14. A device as in claim 1, wherein said sample preparation process is performed for applications from the group consisting of purification of proteins, peptides, DNA and other bio-molecules, size-based separation of molecules, chemical properties based separation of sample components, physical properties based separation of sample components.

15. A device as in claim 1 wherein said sample preparation process can consist of any method used to separate, purify molecules, through centrifugation, gravitation, vacuum suction, pressure application, syringe-based sample delivery through the container, or any other applicable methods.

16. A device as in claim 1, wherein said perforated surface can be coated with a coating which can possess a retention property for analytes or biomolecules and the coating method is selected from the group consisting of spray; screen; printing; dipping; brushing; powder coating; wet coating; and combinations thereof.

17. A device as in claim 1 , wherein the said perforated surface has two sides, which are connected through the said holes, the said each side contain different said chromatographic particles to achieve selective preparation and purification of said sample.

18. A device as in claim 1, wherein said perforated surface contains molecules for further reactions selected from the group consisting of MALDI-matrix, enzymes; reactive metals; catalyst; affinity molecules; receptors; oxidizing and reducing molecules; and, combination thereof.

19. A device as in claim 1, wherein the perforated surface attached to a thin-layer chromatography plate or film.

20. A device as in claim 1, wherein the thickness of the said perforated surface can be in between 0.0001-10 mm and the distance between two said holes on said surface can be between 0.0001-10 mm.
